(19) United States
(12) Patent Application Publication
(10) Pub. No.: US 2023/0376750 A1
(43) Pub. Date: Nov. 23, 2023

(54) METHOD AND APPARATUS FOR RECOMMENDING USER PREFERENCES BASED ON NEURAL SET OPERATIONS

(71) Applicant: BINJIANG INSTITUTE OF ZHEJIANG UNIVERSITY, Hangzhou (CN)

(72) Inventors: MENG HAN, HANGZHOU (CN); MING LI, HANGZHOU (CN); CHANGTING LIN, HANGZHOU (CN); WEIPING YU, HANGZHOU (CN); JIANFENG DONG, HANGZHOU (CN); WENTAO DU, HANGZHOU (CN); BIN WANG, HANGZHOU (CN)

(21) Appl. No.: 17/993,839

(22) Filed: Nov. 23, 2022

(30) Foreign Application Priority Data
May 17, 2022 (CN) 2022105338057

(51) Int. Cl. G06N 3/08

(52) U.S. Cl. CPC G06N 3/08

(57) ABSTRACT

The present invention discloses a method and apparatus for recommending user preferences based on neural set operations, wherein on the basis of obtaining a positive feedback interaction sequence and a negative feedback interaction sequence and user global preference information, a sequence of positive feedback interaction vectors and a sequence of negative feedback interaction vectors corresponding to the positive feedback interaction sequence and the negative feedback interaction sequence are simultaneously combined, and the positive feedback preference representation and the negative feedback preference representation are obtained using the ensemble operation. After that, the comprehensive user preference representation is obtained by feeding an MLP with the concatenation of the positive, negative, and global user preference embeddings, and finally the recommendation score is evaluated by calculating the similarity between the comprehensive user preference representation and the vector corresponding to the candidate interaction item, and the user preference recommendation is realized based on the recommendation score, which can improve the accuracy.

### TECHNICAL FIELD

The present invention relates to the technical field of intersection of neural networks and recommendations, and specifically to a method and apparatus for recommending user preferences based on the neural set operations.

### BACKGROUND TECHNOLOGY

Recommender systems (RSs) are widely used in online services and shopping platforms and contribute significantly to the success of today's businesses. RSs can learn users' preference representations from their historical feedback and recommend personalized items to users. In real-world RSs, the amount of implicit feedback is much more than explicit feedback due to the predominance of items not being clicked, so it is crucial for recommender systems to learn users' preference representations from the implicit feedback. In implicit feedback, some items that users observe as selected are considered positive feedback because they indicate the user's preference for those items, while unobserved items are usually considered negative feedback. When learning user preferences using a recommender system in order to make personalized recommendations, both positive and negative user preferences are critical to the accuracy of the recommendations.

Memory-based collaborative filtering (CF) methods have been successfully applied to RSs. Early CF methods use a direct representation of users and items using a user-item binary interaction matrix and apply a similarity function to compute a match score between each user and a candidate item. Although CF methods are simpler, they suffer from the sparsity problems, because the user preference representation is built directly from the interactions of all items and the interactions are usually few.

To address the sparsity problem of user preference representations in traditional CF methods, model-based CF methods are commonly used in RSs to learn user preferences as real-valued vectors using feedback information as training samples. One of the more representative ones is the Matrix Factorization (MF) technique, which learns user and item representations in the potential space and uses dot product to measure the matching score. Although the MF technique overcomes the sparsity problem, the expressiveness of the learned user preference representations is limited and this linear mapping cannot be guaranteed since it assumes a linear mapping between the original representation space and the latent space.

Deep Neural Networks (DNNs) have shown excellent performance in the field of representation learning, and DNNs have also been applied to improve the performance of recommender systems. Recurrent Neural Network (RNN) learns user preferences from user item interactions originating from historical sessions and uses attention mechanisms for fine-grained user preference extraction. Although deep learning-based recommendation systems can achieve state-of-the-art performance on many recommendation tasks, existing models either focus only on positive feedback (e.g., clicks) user preference representations, or ignore content that users dislike, or directly compress positive and negative user preferences into a fixed-length embedding representation. This approach can limit the amount of information in the user preference representation, resulting in a performance penalty for such models.

### SUMMARY OF THE INVENTION

In view of the foregoing, it is an object of the present invention to provide a method and apparatus for recommending user preferences based on neural set operations, combining both positive and negative feedback items of a user and global preference information of a user, and using a neural network embedded with ensemble operations to learn the comprehensive preference representation of a user and perform preference recommendation based on such user preference representation, improving the accuracy of the recommendation.

To achieve the above-mentioned purpose of the invention, embodiments provide a method for recommending user preferences based on neural set operations, comprising the following steps:
Extracting all positive feedback interaction items and negative feedback interaction items from user interaction history information, and constructing positive feedback interaction sequences and negative feedback interaction sequences respectively by arranging all positive feedback interaction items and negative feedback interaction items in the order of interaction time; obtaining user global preference information;
Encoding positive and negative feedback interaction sequences into a sequence of positive and negative feedback interaction vectors, respectively, and encoding user global preference information into a user global preference vector;
Learning comprehensive preference representation with the neural set operations model including set operation and multi-layer perceptron, comprising performing a union operation on a time-nearest plurality of positive feedback interaction vectors drawn from a sequence of positive feedback interaction vectors followed by a difference operation with a time-nearest plurality of negative feedback interaction vectors drawn from a sequence of negative feedback interaction vectors to obtain a positive feedback preference representation; after performing a union operation on a time-nearest plurality of negative feedback interaction vectors extracted from the negative feedback interaction vector sequence, performing the difference set operation on a time-nearest plurality of positive feedback interaction vectors from the positive feedback interaction vector sequence to obtain negative feedback preference representation; the positive feedback preference representation, the negative feedback preference representation and the global user preference embeddings are mapped using a multi-layer perceptron to obtain the comprehensive user preference representation;
The similarity between the comprehensive user preference representation and the corresponding vector of multiple candidate interaction items is calculated, and the similarity is used as the recommendation score to rank the candidate interaction items, and the user preference is recommended based on the ranking result;
To achieve the above mentioned object of the present invention, embodiments further provide a user preference recommendation device based on neural set operations, comprising a memory, a processor and a computer program stored in said memory and executable on said processor, said memory having stored in it the neural set operations model constructed by the above-mentioned user preference recommendation method based on neural set operations, said processor executing computer program implements as the following steps:
Extracting all positive feedback interaction items and negative feedback interaction items from user interaction history information, and arrange all positive feedback interaction items and negative feedback interaction items in chronological order to construct positive feedback interaction sequences and negative feedback interaction sequences respectively; obtain user global preference information;
Encoding positive and negative feedback interaction sequences into a sequence of positive and negative feedback interaction vectors, respectively, and encoding user global preference information into a user global preference vector;
Learning comprehensive preference representation with the neural set operations model including set operation and multi-layer perceptron, comprising performing a union operation on a time-nearest plurality of positive feedback interaction vectors drawn from a sequence of positive feedback interaction vectors followed by a difference operation with the time-nearest plurality of negative feedback interaction vectors drawn from the sequence of negative feedback interaction vectors to obtain the positive feedback preference representation; performing a union operation on a time-nearest plurality of negative feedback interaction vectors extracted from the negative feedback interaction vector sequence, performing the difference set operation on a time-nearest plurality of positive feedback interaction vectors from the positive feedback interaction vector sequence to obtain negative feedback preference representation; the positive feedback preference representation, the negative feedback preference representation, and the global user preference embeddings are mapped using a multi-layer perceptron to obtain the comprehensive user preference representation;
The similarity between the comprehensive user preference representation and the corresponding vector of multiple candidate interaction items is calculated, and the similarity is used as the recommendation score to rank the candidate interaction items, and the user preference is recommended based on the ranking result.

Compared to the prior art, the present invention owns beneficial effects including at least:

On the basis of obtaining the positive feedback interaction sequence and negative feedback interaction sequence and the user global preference information, combining both the positive feedback interaction sequence and the negative feedback interaction vector sequence corresponding to the positive feedback interaction sequence and the negative feedback interaction vector sequence, and after using the set operation to obtain the positive feedback preference representation and the negative feedback preference representation, the multi-layer perceptron is used to map the positive feedback preference representation and negative feedback preference representation and the global user preference embeddings corresponding to the user global preference information to obtain the user integrated preference representation, so that the user integrated preference representation includes the positive feedback and negative feedback information, and the information is not compressed to ensure the accuracy of the information. recommendation, which can improve the accuracy of user preference recommendation.

### BRIEF DESCRIPTION OF THE DRAWINGS

In order to clearly illustrate the technical solutions in the embodiments or prior art of the present invention, the accompanying drawings required for use in the description of the embodiments or prior art will be briefly described below, and it will be apparent that the accompanying drawings in the following description are only some embodiments of the present invention, and that other accompanying drawings may be obtained from these drawings without creative labor to a person of ordinary skill in the art.

FIG. 1 is a flowchart of a method for recommending user preferences based on neural set operations;

FIG. 2 is a diagram of the process of integrated preference representation learning by the neural set operations model provided by the embodiment.

### SPECIFIC EMBODIMENTS OF THE INVENTION

In order to achieve the object, technical solutions and advantages of the present invention more clearly understood, the present invention is described in further detail hereinafter in conjunction with the accompanying drawings and embodiments. It should be understood that the specific embodiments described herein are intended only to explain the present invention and do not limit the scope of protection of the present invention.

Based on the problems existing in the background technology, embodiments provide a method and apparatus for recommending user preferences based on neural set operations, which makes full use of the information of negative feedback interaction terms corresponding to negative preferences, based on which the corresponding vectors of positive feedback interaction terms and negative feedback interaction terms of the user are ensemble operated to learn dependencies between the interaction terms and generate positive feedback preference representation and negative feedback preference representation, and then, by providing the MLP with the positive feedback preference representation and negative feedback preference representation and the crosstalk of the user's global preference representation corresponding to the user's global preference information, into the mapping calculation to obtain the user's integrated preference representation, so that the obtained integrated preference representation contains a complete and accurate amount of information. The recommendation scores for candidate interaction items computed based on the accurate composite preference representation are also accurate, which in turn improves the accuracy of user preference recommendations.

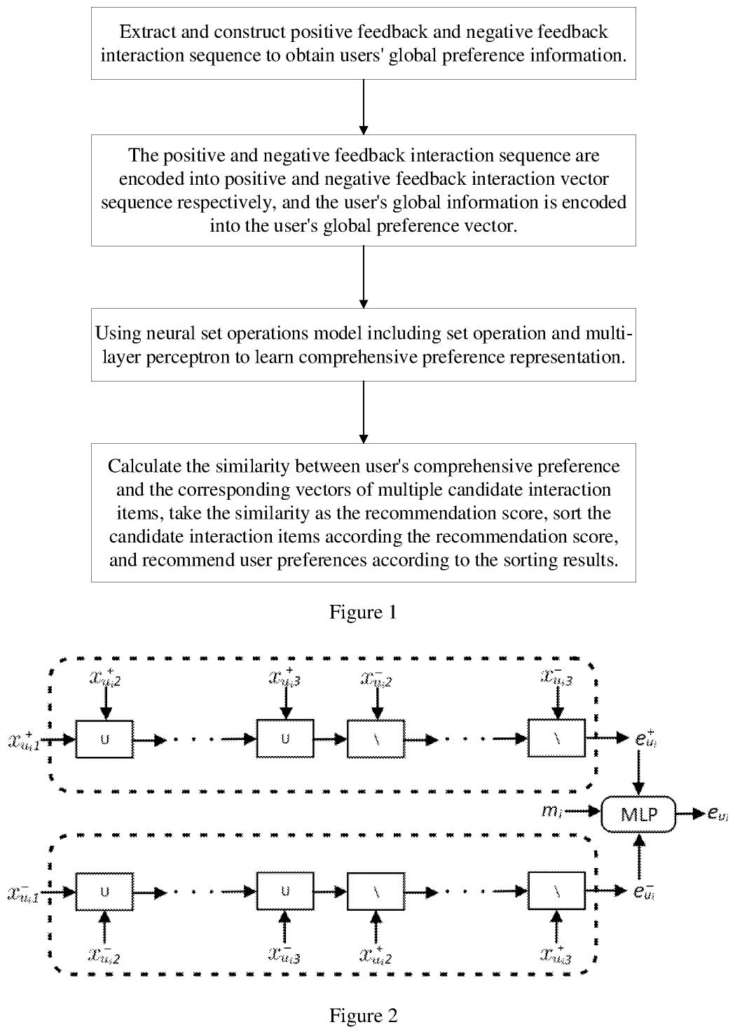

FIG. 1 is a flowchart of a user preference recommendation method based on neural set operations provided by an embodiment. As shown in FIG. 1, the user preference recommendation method based on neural set operations provided by the embodiment comprises the following steps:
Step 1, extracting and constructing a positive feedback interaction sequence and a negative feedback interaction sequence to obtain the user global preference information.

In the embodiment, first obtaining the user from the user shopping platform, community platform, and other interaction platforms with the recommended application uᵢ historical interaction information V, and extracting all positive feedback interaction items and negative feedback interaction items from the user's historical interaction information V, and vᵤ_{ᵢ}ⱼ⁺ and negative feedback interaction items vᵤ_{ᵢ}ⱼ⁻, and constructing positive feedback interaction sequences and negative feedback interaction sequences respectively according to the interaction time order vᵤ_{ᵢ}⁺ and negative feedback interaction sequences vᵤ_{ᵢ}⁻ where positive feedback interaction items are items that users click or like; negative feedback interaction items are items that users do not click or dislike.
Step 2, encoding the positive feedback interaction sequence and the negative feedback interaction sequence into a sequence of positive feedback interaction vectors and a sequence of negative feedback interaction vectors, respectively, and encoding the user global preference information into a user global preference vector.

In embodiments, an encoder may be used to combine all positive feedback interaction terms vᵤ_{ᵢ}ⱼ⁺ and positive feedback interaction terms vᵤ_{ᵢ}_{j′}⁻ into a positive feedback interaction vector xᵤ_{ᵢ}ⱼ⁺ and negative feedback interaction vectors xᵤ_{ᵢ}_{j′}⁺ to form a sequence of positive feedback interaction vectors Xᵤ_{ᵢ}⁺ and a sequence of negative feedback interaction vectors Xᵤ_{ᵢ}⁻ where the positive feedback interaction vector xᵤ_{ᵢ}ⱼ⁺ has the same dimension as the negative feedback interaction vector xᵤ_{ᵢ}_{j′}⁻ and the encoder may be a pre-trained neural network structure. In embodiments, the encoder can also be used to encode the user global preference information p into a global user preference embedding mᵢ.
In step 3, integrated preference representation learning is performed using the neural set operations model containing ensemble operations and multi-layer perceptron.

In embodiments, the neural set operations model models the positive and negative preference information of a user in order to more fully learn a comprehensive preference representation of the user. Ensemble operations are well suited for manipulating members of an ensemble, and the feedback interaction vectors corresponding to feedback interaction terms (both positive and negative feedback interaction terms) can be naturally viewed as containing a set of features. Thus, the preference feature extraction problem can be reduced to implementing ensemble operations among the feedback interaction vectors. Due to the discrete nature of the feedback interaction term data, learning ensemble operations from the data by optimization methods is highly challenging. Therefore, the ability to combine the distributed representation and generalized approximation of neural networks in the present invention to learn set operations as functions to distinguish between user like information and dislike information by user interaction history. Among others, the set operations include the union operation (UNION, ∪), difference set operations (DIFFERENCE, \) and intersection operations INTERSECTION, ∩).

In the implementation example, when performing integrated preference representation learning, the merge set operation (∪) and the difference set operation (\). A multi-layer perceptron (MLP) is an artificial neural network with multiple hidden layers in between in addition to the input layer and the output layer before, and the computational process is achieved through a fully connected mapping between the layers. In embodiments, the multi-layer perceptron may employ an artificial neural network containing 2 hidden layers for the computation of a mapping of multi-dimensional vectors to obtain a user integrated preference representation.

In the embodiment, the attempt to combine the user uᵢ corresponding to all positive and negative feedback interaction items with which the user may interact, it was found that the number of combinations would potentially become large, and after much exploration, the present invention uses sampling the nearest k items of positive and negative feedback interaction items separately for user preference representation learning first, rather than sampling the entire user interaction items and then performing comprehensive user preference representation based on preference representation learning. As shown in FIG. 2, specifically, the learning process includes:

(a) after performing a union operation on the time-nearest multiple positive feedback interaction vectors drawn from the sequence of positive feedback interaction vectors, a difference operation is performed with the time-nearest multiple negative feedback interaction vectors drawn from the sequence of negative feedback interaction vectors to obtain a positive feedback preference representation.

In embodiments, the specific process of the step (a) includes:

First, the k time-nearest positive feedback interaction vectors drawn from the sequence of positive feedback interaction vectors, and the union operation is performed on these k positive feedback interaction vectors in turn to obtain the joint embedding vector of the k positive feedback interaction vectors hᵤ_{ᵢ}⁺, denoted as:

hᵤ_{ᵢ}⁺=UNION(xᵤ_{ᵢ}ⱼ⁺),xᵤ_{ᵢ}ⱼ⁺∈Xᵤ_{ᵢ}⁺ (1)
where UNION( ) denotes the concatenation operation, and xᵤ_{ᵢ}ⱼ⁺ denotes the jth positive feedback interaction vector, and Xᵤ_{ᵢ}⁺ denotes the ith user uᵢ corresponding sequence of positive feedback interaction vectors.

Equation (1) is understood as follows: for the j-th positive feedback interaction vector xᵤ_{ᵢ}ⱼ⁺ with the j+1-th positive feedback interaction vector xᵤ_{ᵢ}₍ⱼ₊₁₎⁺, the result of the union operation xᵤ_{ᵢ}ⱼ⁺∪xᵤ_{ᵢ}₍ⱼ₊₁₎⁺ is obtained, then using the result of the union operation xᵤ_{ᵢ}ⱼ⁺∪xᵤ_{ᵢ}₍ⱼ₊₁₎⁺ with the j+2th positive feedback interaction vector xᵤ_{ᵢ}₍ⱼ₊₂₎⁺ to obtain the result of the concatenation operation xᵤ_{ᵢ}ⱼ⁺∪xᵤ_{ᵢ}₍ⱼ₊₁₎∪xᵤ_{ᵢ}₍ⱼ₊₂₎, until the k positive feedback interaction vectors are all concatenated to obtain the joint embedding vector of the k positive feedback interaction vectors hᵤ_{ᵢ}⁺.

Then, the k time-nearest negative feedback interaction vectors drawn from the sequence of negative feedback interaction vectors, the joint embedding vector hᵤ_{ᵢ}⁺ with the k negative feedback interaction vectors in order to perform the difference set operation to obtain the positive feedback preference representation eᵤ_{ᵢ}⁺, denoted as:

eᵤ_{ᵢ}⁺=DIFFERENCE(hᵤ_{ᵢ}⁺,xᵤ_{ᵢ}_{j′}⁻),xᵤ_{ᵢ}_{j′}⁻∈Xᵤ_{ᵢ}⁻ (2)
where DIFFERENCE ( ) denotes the difference set operation, and xᵤ_{ᵢ}_{j′}⁻ denotes the first j′ negative feedback interaction vector, and Xᵤ_{ᵢ}⁻ denotes the i-th user's corresponding sequence of negative feedback interaction vectors.

Equation (2) is understood as follows: for the joint embedding vector hᵤ_{ᵢ}⁺ with the first j′ negative feedback interaction vector xᵤ_{ᵢ}_{j′}⁻, and the difference set operation is performed to obtain hᵤ_{ᵢ}⁺\xᵤ_{ᵢ}_{j′}⁻, and the difference operation is performed to obtain the result of the difference operation hᵤ_{ᵢ}⁺\xᵤ_{ᵢ}_{j′}⁻\xᵤ_{ᵢ}_{(j′+1)}⁻ with hᵤ_{ᵢ}⁺\xᵤ_{ᵢ}_{j′}⁻ and the j′+1 negative feedback interaction vector xᵤ_{ᵢ}_{(j′+1)}⁻, until the k negative feedback interaction vectors are differenced to obtain a positive feedback preference representation eᵤ_{ᵢ}⁺.

Step (a) presents the positive feedback preference representation learning process, the positive feedback preference representation is reflected by the features in the positive feedback interaction items, but not all features in the positive feedback interaction items contribute to positive feedback on the items, but only some of the key features determine liking preferences, so the features in the negative feedback interaction items are removed when extracting the positive feedback preference representation.

(b) the time-nearest multiple negative feedback interaction vectors drawn from the sequence of negative feedback interaction vectors are merged and then differenced with the time-nearest multiple positive feedback interaction vectors drawn from the sequence of positive feedback interaction vectors to obtain the negative feedback preference representation.

In embodiments, the specific process of the step (b) includes: First, the k time-nearest negative feedback interaction vectors drawn from the sequence of negative feedback interaction vectors, and the union operation is performed on these k negative feedback interaction vectors in turn to obtain the joint embedding vector of the k negative feedback interaction vectors hᵤ_{ᵢ}⁻, denoted as.

hᵤ_{ᵢ}⁻=UNION(xᵤ_{ᵢ}_{j′}⁻)xᵤ_{ᵢ}_{j′}⁻∈xᵤ_{ᵢ}⁻ (3)
wherein UNION( ) denotes the union operation, and xᵤ_{ᵢ}_{j′}⁻ denotes the first j′ negative feedback interaction vector, and Xᵤ_{ᵢ}⁻ denotes the i-th user uᵢ corresponding sequence of negative feedback interaction vectors;

Equation (3) is understood as follows: for the first j′ negative feedback interaction vector xᵤ_{ᵢ}_{j′}⁻ with the first j′+1 negative feedback interaction vector xᵤ_{ᵢ}_{(j′+1)}⁻, the result of the union operation xᵤ_{ᵢ}_{j′}⁻∪xᵤ_{ᵢ}_{(j′+1)}⁻ is obtained, and using the result of the union operation xᵤ_{ᵢ}_{j′}⁻∪xᵤ_{ᵢ}_{(j′+1)}⁻ with the j′+2 negative feedback interaction vector xᵤ_{ᵢ}_{(J′+2)}⁻ to obtain the result of the concatenation operation xᵤ_{ᵢ}_{j′}⁻∪xᵤ_{ᵢ}_{(j′+1)}⁻∪xᵤ_{ᵢ}_{(J′+2)}⁻ and so on, until the k negative feedback interaction vectors are all merged to obtain the joint embedding vector of the k negative feedback interaction vectors hᵤ_{ᵢ}⁻.

Then, the k time-nearest positive feedback interaction vectors drawn from the sequence of positive feedback interaction vectors, the joint embedding vector hᵤ_{ᵢ}⁻ with the k positive feedback interaction vectors in turn to perform a difference-set operation to obtain the negative feedback preference representation eᵤ_{ᵢ}⁻, denoted as:

eᵤ_{ᵢ}⁻=DIFFERENCE(hᵤ_{ᵢ}⁻,xᵤ_{ᵢ}ⱼ⁺),xᵤ_{ᵢ}ⱼ⁺∈Xᵤ_{ᵢ}⁺ (4)
wherein DIFFERENCE ( ) denotes the difference set operation, and xᵤ_{ᵢ}ⱼ⁺ denotes the j-th positive feedback interaction vector, and Xᵤ_{ᵢ}⁺ denotes the user uᵢ the corresponding sequence of positive feedback interaction vectors;

Equation (4) is understood as follows: for the joint embedding vector hᵤ_{ᵢ}⁻ with the j-th positive feedback interaction vector xᵤ_{ᵢ}ⱼ⁺, performing a difference operation to obtain the result of the difference operation hᵤ_{ᵢ}⁻\xᵤ_{ᵢ}ⱼ⁺, and the result of the difference set operation hᵤ_{ᵢ}⁻\xᵤ_{ᵢ}ⱼ⁺ with the j+1-th positive feedback interaction vector xᵤ_{ᵢ}₍ⱼ₊₁₎⁺ to obtain the result of the difference operation and so on, until the k positive feedback interaction vectors are used to obtain the negative feedback preference representation eᵤ_{ᵢ}⁻.

Step (b) presents the negative feedback preference representation learning process, the negative feedback preference representation is reflected by the features in the negative feedback interaction items, but not all features in the negative feedback interaction items contribute to negative feedback on the items, but only some of the key features decide to dislike the preference, so the features in the positive feedback interaction items are removed when extracting the negative feedback preference representation.

(c) mapping of positive feedback preference representations, negative feedback preference representations and global user preference vectors using a multi-layer perceptron to obtain a composite user preference representation.

In embodiments, the specific process of step (c) comprises.

The positive feedback preference representation, the negative feedback preference representation, and the global user preference embeddings are first concatenated, and then the mapping of the concatenated results is computed using a multi-layer perceptron in order to obtain the comprehensive user preference representation, denoted as:

eᵤ_{ᵢ}=MLP(concat(eᵤ_{ᵢ}⁺,eᵤ_{ᵢ}⁻,mᵢ)) (5)
wherein eᵤ_{ᵢ}⁻ denotes the comprehensive user preference representation with the same dimensionality as the positive feedback interaction vector, and uᵢ denotes the i-th user, and eᵤ_{ᵢ}⁺ denotes the positive feedback preference representation, the eᵤ_{ᵢ}− denotes the negative feedback preference representation, and in, denotes the global user preference embedding for the ith user, and concat ( ) denotes the tandem operation, and MLP ( ) denotes the mapping computation corresponding to the multi-layer perceptron.

In the implementation, the neural set operations model needs to be parameter optimized before being applied, and in order to distinguish positive feedback interaction terms, negative feedback interaction terms as far as possible, a Bayesian Personalized Ranking (BPR) loss function to maximize the difference between the recommendation scores of positive and negative feedback interaction terms.

In embodiments, each ensemble operation is embedded in the learning process of the MLP, and the MLP can be used to learn the ensemble operations guided by the optimization objective. To ensure that the neural set operations model can perform the desired ensemble operations, an ensemble regularizer is applied to guide the learning of the neural set operations model. For example, any set with the empty set (EMPTY, Ø) is the intersection of the empty set, and the union of any set with the empty set is the set itself. The null vector is a random initialization vector that is used to guide the learning of other vectors and will not be optimized along with other model parameters. Table 1 gives all the set operations applied in the optimization process and the corresponding regularization constraints methods.

TABLE 1
Set operations and regularization constraint methods

| Set | Operation | |
|---|---|---|
| operations | rules | Regularization constraint methods |
| union | z = z ∪ ∅ | 1-DEC(UNION(z,EMPTY),EMPTY) |
| | z = z ∪ z | 1-DEC(UNION(z,z),z) |
| intersection | ∅ = z ∩ ∅ | 1-DEC(INTERSECTION(z,EMPTY),EMPTY) |
| | z = z ∩ z | 1-DEC(INTERSECTION(z,z),z) |
| difference | z = z\∅ | 1-DEC(DIFFERENCE(z,EMPTY),z) |
| | ∅ = ∅\z | 1-DEC(DIFFERENCE(EMPTY,z),EMPTY) |

Taking the union operation as an example, as shown in Table 1, the union operation shall satisfy z=z∪Ø, so that the merge of any feature set embedding representation and the empty set embedding representation should be the feature set embedding itself. To constrain the neural set operations model to perform the expected ensemble operation, the regularization loss of the union operation is specified as 1−DEC(UNION(z,EMPTY),z); wherein DEC(⋅) denotes the similarity function, and the present invention utilizes a cosine similarity function. The smaller the regularization loss is, the smaller the union operation UNION(z, EMPTY) and Z the greater the similarity between them, and the final loss is the average loss of the entire Z set, i.e.

$$f ( z ) = \frac{1}{\vert z \vert} {\sum }_{z ∈ Z} 1 - D E C ( UNION ( z , EMPTY ) .$$

The regularization constraints corresponding to all other set operations listed in Table 1 are constrained in the same way.

Based on the above analysis, the loss function used for parameter optimization in the embodiment is:

L=L_{SNOM}+λᵣL_{SetReg} (6)
where L denotes the loss function, and L_{SNOM} denotes the Bayesian personalized ranking loss corresponding to the recommendation, and L_{SetReg} denotes the regularization constraint loss, and λᵣ denotes the regularization constraint loss L_{SetReg} the weights of the recommendations.

Bayesian personalized ranking loss L_{SNOM} Sampling one negative feedback interaction term for each positive feedback interaction term pair, denoted as

$${L}_{S N O M} = - {\sum }_{{m}_{i} ∈ M} {\sum }_{{x}_{{u}_{i} j}^{+} ∈ {X}_{{u}_{i}}^{+}} {\sum }_{{x}_{{u}_{i} {j}^{′}}^{-} ∈ {X}_{{u}_{i}}^{-}} ln σ ( {\hat{y}}_{{u}_{i} j} - {\hat{y}}_{{u}_{i} {j}^{′}} ) + {λ}_{θ} {‖ θ ‖}^{2} \qquad ( 7 )$$

where in, denotes the global user preference embedding for the i-th user, M denotes the sequence of global user preference embeddings, xᵤ_{ᵢ}ⱼ⁺ denotes the j-th positive feedback interaction vector, Xᵤ_{ᵢ}⁺ denotes the i-th user uᵢ corresponding sequence of positive feedback interaction vectors, xᵤ_{ᵢ}_{j′}⁻ denotes the j′ negative feedback interaction vector, Xᵤ_{ᵢ}⁻ denotes the i-th user uᵢ corresponding negative feedback interaction vector sequence, σ( ) denotes the sigmoid function, ŷᵤ_{ᵢ}ⱼ denotes the recommendation score calculated from the comprehensive user preference representation and the positive feedback interaction vector in the training set, ŷᵤ_{ᵢ}_{j′} denotes the recommendation score computed from the comprehensive user preference representation and the negative feedback interaction vector in the training set, θ denotes the model parameters, ∥θ∥² denotes the regularization of the model parameters L2 regularization, and λ_{θ} denotes the weights. The greater the difference between the recommendation score corresponding to the positive feedback interaction item and the recommendation score corresponding to the negative feedback interaction item, the smaller the L_{SNOM} loss.

The regularization constraint loss L_{SetReg} is expressed as:

$${L}_{SetReg} = {\sum }_{f ( z ) ∈ R} ( \frac{1}{\vert z \vert} {Σ}_{z ∈ Z} f ( z ) ) \qquad ( 8 )$$

where z is a set of vectors including a sequence of positive feedback interaction vectors corresponding to a single input sample, a sequence of negative feedback interaction vectors, and a vector of global user preferences, the positive feedback preference representation and the negative feedback preference representation obtained by the set operation, and the comprehensive user preference representation computed by the multi-layer perceptron mapping, Z denotes the set of z corresponding to multiple input samples, and ƒ(z) denotes the single regularization constraint function corresponding to the ensemble operation, and R is the set of regularization constraint functions including the ƒ(z) as:

ƒ(z)=1−DEC(UNION(z,EMPTY),EMPTY)

ƒ(z)=1−DEC(UNION(z,z),z)

ƒ(z)=1−DEC(INTERSECTION(z,EMPTY),EMPTY)

ƒ(z)=1−DEC(INTERSECTION(z,z),z)

ƒ(z)=1−DEC(DIFFERENCE(z,EMPTY),z)

ƒ(z)=1−DEC(DIFFERENCE(EMPTY,z),EMPTY)

where EMPTY is a randomly initialized vector, UNION( ) denotes the union operation, DEC( ) denotes the similarity function, DIFFERENCE( ) denotes the difference operation, and DIFFERENCE( ) denotes the intersection operation.

In the implementation, the parameters are optimized according to the constructed loss function L using the backpropagation method.

Step 4, calculating the similarity of the comprehensive user preference representation to the corresponding vectors of the plurality of candidate 2interaction items respectively, using the similarity as a recommendation score, ranking the candidate interaction items according to the recommendation score, and performing user preference recommendation based on the ranking result.

In the embodiment, for each candidate interaction item in the given candidate interaction sequence corresponding to the vector xⱼ, the cosine similarity between the user comprehensive preference representation and the vector xⱼ corresponding to each candidate interaction item is calculated, and the cosine similarity is used as the recommendation score. After obtaining the recommendation scores corresponding to all candidate interaction items, the candidate interaction items are sorted in descending order according to the recommendation scores, and the top L candidate interaction items are selected for user preference recommendation based on the sorting results.

Based on the same inventive concept, embodiments also provide a user preference recommendation device based on neural set operations, comprising a memory, a processor, and a computer program stored in the memory and executable on the processor, wherein the memory stores the neural set operations model constructed by the user preference recommendation method based on neural set operations as shown in FIG. 1, and the processor executes said computer program implements the steps of:
Step 1, extracting and constructing a positive feedback interaction sequence and a negative feedback interaction sequence to obtain the user global preference information.
Step 2, encoding the positive feedback interaction sequence and the negative feedback interaction sequence into a sequence of positive feedback interaction vectors and a sequence of negative feedback interaction vectors, respectively, and encoding the user global preference information into a user global preference vector.
Step 3, learning comprehensive preference representation with the neural set operations model including set operation and multi-layer perceptron, containing ensemble operations and multi-layer perceptron.

The step comprises: (a) performing a merging operation on the time-nearest multiple positive feedback interaction vectors drawn from a sequence of positive feedback interaction vectors, followed by a differencing operation with the time-nearest multiple negative feedback interaction vectors drawn from a sequence of negative feedback interaction vectors to obtain a positive feedback preference representation; (b) performing a merging operation on the time-nearest multiple negative feedback interaction vectors drawn from a sequence of negative feedback interaction vectors (b) after merging the time-nearest negative feedback interaction vectors extracted from the negative feedback interaction vector sequence with the time-nearest positive feedback interaction vectors extracted from the positive feedback interaction vector sequence, perform a difference-set operation to obtain the negative feedback preference representation; (c) using a multi-layer perceptron to compute a mapping of the positive feedback preference representation, the negative feedback preference representation, and the global user preference embeddings to obtain the comprehensive user preference representation.
Step 4, calculating the similarity of the comprehensive user preference representation to the corresponding vectors of the plurality of candidate interaction items respectively, using the similarity as a recommendation score, ranking the candidate interaction items according to the recommendation score, and making user preference recommendations based on the ranking results.

In practice, the memory can be volatile memory at the near end, such as RAM, or non-volatile memory, such as ROM, FLASH, floppy disk, mechanical hard disk, etc., or a remote storage cloud. The processor can be a central processing unit (CPU), a microprocessor (MPU), a digital signal processor (DSP), or a field programmable gate array (FPGA), i.e., a user preference recommendation step based on the operation of a neural network ensemble can be implemented by these processors.

The above-described embodiments provide a method and apparatus for recommending user preferences based on neural set operations, combining both positive and negative feedback items of a user and global preference information of a user, and to learn a comprehensive preference representation of a user with the neural set operations and make preference recommendations based on such user preference representation, improving the accuracy of the recommendations.

The above-described specific embodiments provide a detailed description of the technical solutions and beneficial effects of the present invention, and it should be understood that the above-described are only the most preferred embodiments of the present invention and are not intended to limit the present invention, and any modifications, additions and equivalent replacements, etc. made within the principles of the present invention shall be included in the scope of protection of the present invention.

1. A method for recommending user preferences based on neural set operations, comprising the following steps:
extracting all positive feedback interaction items and negative feedback interaction items from user interaction history information, and constructing positive feedback interaction sequences and negative feedback interaction sequences respectively by arranging all positive feedback interaction items and negative feedback interaction items in the order of interaction time; obtain user global preference information;
encoding positive and negative feedback interaction sequences into a sequence of positive and negative feedback interaction vectors, respectively, and encoding user global preference information into a user global preference vector;
learning comprehensive preference representation with the neural set operations model including set operation and multi-layer perceptron, comprising performing a union operation on a time-nearest plurality of positive feedback interaction vectors drawn from a sequence of positive feedback interaction vectors followed by a difference operation with a time-nearest plurality of negative feedback interaction vectors drawn from a sequence of negative feedback interaction vectors to obtain a positive feedback preference representation; after performing a union operation on a time-nearest plurality of negative feedback interaction vectors extracted from the negative feedback interaction vector sequence, performing the difference set operation on a time-nearest plurality of positive feedback interaction vectors from the positive feedback interaction vector sequence to obtain negative feedback preference representation; the positive feedback preference representation, the positive feedback preference representation, the negative feedback preference representation and the global user preference embeddings are mapped using a multi-layer perceptron to obtain the comprehensive user preference representation;
calculating similarity between the comprehensive user preference representation and the corresponding vector of multiple candidate interaction items and the similarity is used as the recommendation score to rank the candidate interaction items, and recommending the user preference based on the ranking result.

2. The method for recommending user preferences based on neural set operations according to claim 1, characterized in that after performing a union operation on the time-nearest multiple positive feedback interaction vectors drawn from the sequence of positive feedback interaction vectors, performing a difference operation with the time-nearest multiple negative feedback interaction vectors drawn from the sequence of negative feedback interaction vectors to obtain a positive feedback preference representation; the specific process of performing the difference operation comprises:
first, drawing the k time-nearest positive feedback interaction vectors from the sequence of positive feedback interaction vectors, and the union operation is performed on these k positive feedback interaction vectors in turn to obtain the joint embedding vector of the k positive feedback interaction vectors hᵤ_{ᵢ}⁺, denoted as,
hᵤ_{ᵢ}⁺=UNION(xᵤ_{ᵢ}ⱼ⁺),xᵤ_{ᵢ}ⱼ⁺∈Xᵤ_{ᵢ}⁺ (1)
where UNION( ) denotes the concatenation operation, and xᵤ_{ᵢ}ⱼ⁺ denotes the jth positive feedback interaction vector, and Xᵤ_{ᵢ}⁺ denotes the ith user uᵢ corresponding sequence of positive feedback interaction vectors;
wherein the equation (1) is understood as follows: for the j-th positive feedback interaction vector xᵤ_{ᵢ}ⱼ⁺ with the j+1-th positive feedback interaction vector xᵤ_{ᵢ}₍ⱼ₊₁₎⁺, the result of the union operation xᵤ_{ᵢ}ⱼ⁺∪xᵤ_{ᵢ}₍ⱼ₊₁₎⁺ is obtained, then using the result of the union operation xᵤ_{ᵢ}ⱼ⁺∪xᵤ_{ᵢ}₍ⱼ₊₁₎⁺ with the j+2th positive feedback interaction vector xᵤ_{ᵢ}₍ⱼ₊₂₎⁺ to obtain the result of the concatenation operation xᵤ_{ᵢ}ⱼ⁺∪xᵤ_{ᵢ}₍ⱼ₊₁₎⁺∪xᵤ_{ᵢ}₍ⱼ₊₂₎⁺, until the k positive feedback interaction vectors are all concatenated to obtain the joint embedding vector of the k positive feedback interaction vectors hᵤ_{ᵢ}⁺;
then, drawing he k time-nearest negative feedback interaction vectors drawn from the sequence of negative feedback interaction vectors, the joint embedding vector hᵤ_{ᵢ}⁺ with the k negative feedback interaction vectors in order to perform the difference set operation to obtain the positive feedback preference representation eᵤ_{ᵢ}⁺, denoted as:
eᵤ_{ᵢ}⁺=DIFFERENCE(hᵤ_{ᵢ}⁺,xᵤ_{ᵢ}_{j′}⁻),xᵤ_{ᵢ}_{j′}⁻∈Xᵤ_{ᵢ}⁻ (2)
where DIFFERENCE ( ) denotes the difference set operation, and xᵤ_{ᵢ}_{j′}⁻ denotes the first j′ negative feedback interaction vector, and Xᵤ_{ᵢ}⁻ denotes the i-th user's corresponding sequence of negative feedback interaction vectors;
wherein the equation (2) is understood as follows: for the joint embedding vector hᵤ_{ᵢ}⁺ with the first j′ negative feedback interaction vector xᵤ_{ᵢ}_{j′}⁻, and the difference set operation is performed to obtain hᵤ_{ᵢ}⁺\xᵤ_{ᵢ}_{j′}⁻, and the difference operation is performed to obtain the result of the difference operation hᵤ_{ᵢ}⁺\xᵤ_{ᵢ}_{j′}⁻\xᵤ_{ᵢ}_{(j′+1)}⁻ with hᵤ_{ᵢ}⁺\xᵤ_{ᵢ}_{j′}⁻ and the j′+1 negative feedback interaction vector xᵤ_{ᵢ}_{(j′+1)}⁻, until the k negative feedback interaction vectors are differenced to obtain a positive feedback preference representation eᵤ_{ᵢ}⁺.

3. The method for recommending user preferences based on neural set operations according to claim 1, characterized in that, the time-nearest multiple negative feedback interaction vectors drawn from the sequence of negative feedback interaction vectors are merged and then differenced with the time-nearest multiple positive feedback interaction vectors drawn from the sequence of positive feedback interaction vectors to obtain the negative feedback preference representation; the specific process comprises:
drawing the k time-nearest negative feedback interaction vectors drawn from the sequence of negative feedback interaction vectors, and the union operation is performed on these k negative feedback interaction vectors in turn to obtain the joint embedding vector of the k negative feedback interaction vectors hᵤ_{ᵢ}⁻, denoted as.
hᵤ_{ᵢ}⁻=UNION(xᵤ_{ᵢ}_{j′}⁻)xᵤ_{ᵢ}_{j′}⁻∈xᵤ_{ᵢ}⁻ (3)
wherein UNION( ) denotes the union operation, and xᵤ_{ᵢ}_{j′}⁻ denotes the first j′ negative feedback interaction vector, and Xᵤ_{ᵢ}⁻ denotes the i-th user uᵢ corresponding sequence of negative feedback interaction vectors;
wherein the equation (3) is understood as follows: for the first j′ negative feedback interaction vector xᵤ_{ᵢ}_{j′}⁻ with the first j′+1 negative feedback interaction vector xᵤ_{ᵢ}_{(j′+1)}⁻, the result of the union operation xᵤ_{ᵢ}_{j′}⁻∪xᵤ_{ᵢ}_{(j′+1)}⁻ is obtained, and using the result of the union operation xᵤ_{ᵢ}_{j′}⁻∪xᵤ_{ᵢ}_{(j′+1)}⁻ with the j′+2 negative feedback interaction vector xᵤ_{ᵢ}_{(j′+2)}⁻ to obtain the result of the concatenation operation xᵤ_{ᵢ}_{j′}⁻∪xᵤ_{ᵢ}_{(j′+1)}⁻∪xᵤ_{ᵢ}_{(j′+2)}⁻ and so on, until the k negative feedback interaction vectors are all merged to obtain the joint embedding vector of the k negative feedback interaction vectors hᵤ_{ᵢ}⁻;
then, drawing the k time-nearest positive feedback interaction vectors drawn from the sequence of positive feedback interaction vectors, the joint embedding vector hᵤ_{ᵢ}⁻ with the k positive feedback interaction vectors in turn to perform a difference-set operation to obtain a negative feedback preference representation eᵤ_{ᵢ}⁻, denoted as:
eᵤ_{ᵢ}⁻=DIFFERENCE(hᵤ_{ᵢ}⁻,xᵤ_{ᵢ}ⱼ⁺),xᵤ_{ᵢ}ⱼ⁺∈Xᵤ_{ᵢ}⁺ (4)
wherein DIFFERENCE ( ) denotes the difference set operation, and xᵤ_{ᵢ}ⱼ⁺ denotes the j-th positive feedback interaction vector, and Xᵤ_{ᵢ}⁺ denotes the user uᵢ the corresponding sequence of positive feedback interaction vectors;
wherein the equation (4) is understood as follows: for the joint embedding vector hᵤ_{ᵢ}⁻ with the j-th positive feedback interaction vector xᵤ_{ᵢ}ⱼ⁺, performing a difference operation to obtain the result of the difference operation hᵤ_{ᵢ}⁻\xᵤ_{ᵢ}ⱼ⁺, and the result of the difference set operation hᵤ_{ᵢ}⁻\xᵤ_{ᵢ}ⱼ⁺ with the j+1-th positive feedback interaction vector xᵤ_{ᵢ}₍ⱼ₊₁₎⁺ to obtain the result of the difference operation and so on, until the k positive feedback interaction vectors are used to obtain the negative feedback preference representation eᵤ_{ᵢ}⁻.

4. The method for recommending user preferences based on neural set operations according to claim 1, characterized in that said mapping of positive feedback preference representations, negative feedback preference representations, and user global preference vectors using a multi-layer perceptron is calculated to obtain the comprehensive user preference representation, the above specific process comprises:
first connecting the positive feedback preference representation, the negative feedback preference representation, and the global user preference embeddings, and then computing the mapping of the concatenated results using a multi-layer perceptron in order to obtain the comprehensive user preference representation, denoted as:
eᵤ_{ᵢ}=MLP(concat(eᵤ_{ᵢ}⁺,eᵤ_{ᵢ}⁻,mᵢ)) (5)
wherein eᵤ_{ᵢ} denotes the comprehensive user preference representation, and uᵢ denotes the i-th user, and eᵤ_{ᵢ}⁺ denotes the positive feedback preference representation, and eᵤ_{ᵢ}⁻ denotes the negative feedback preference representation, and mᵢ denotes the global user preference embeddings for the ith user, and concat ( ) denotes the tandem operation, and MLP ( ) denotes the mapping computation corresponding to the multi-layer perceptron.

5. The method for recommending user preferences based on neural set operations according to claim 1, characterized in that said calculating the similarity of the comprehensive user preference representation to the corresponding vector of the plurality of candidate interaction items, respectively, comprises:
calculating the cosine similarity between the comprehensive user preference representation and the corresponding vector of multiple candidate interaction items respectively, and using the cosine similarity as the recommendation score.

6. The method for recommending user preferences based on neural set operations according to claim 1, characterized in that said the neural set operations model is subject to parameter optimization before being applied, the loss function used for parameter optimization being:
L=L_{SNOM}+λᵣL_{SetReg} (6)
wherein L denotes the loss function, L_{SNOM} denotes the Bayesian personalized ranking loss corresponding to the recommendation, L_{SetReg} denotes the regularization constraint loss, λᵣ denotes the regularization constraint loss and L_{SetReg} denotes the weights of the recommendations;
Bayesian personalized ranking loss is denoted as:
$${L}_{S N O M} = - {\sum }_{{m}_{i} ∈ M} {\sum }_{{x}_{{u}_{i} j}^{+} ∈ {X}_{{u}_{i}}^{+}} {\sum }_{{x}_{{u}_{i} {j}^{′}}^{-} ∈ {X}_{{u}_{i}}^{-}} ln σ ( {\hat{y}}_{{u}_{i} j} - {\hat{y}}_{{u}_{i} {j}^{′}} ) + {λ}_{θ} {‖ θ ‖}^{2} \qquad ( 7 )$$
wherein mᵢ denotes the global user preference embedding for the i-th user, M denotes the sequence of global user preference embeddings, xᵤ_{ᵢ}ⱼ⁺ denotes the j-th positive feedback interaction vector, Xᵤ_{ᵢ}⁺ denotes the i-th user uᵢ corresponding sequence of positive feedback interaction vectors, xᵤ_{ᵢ}_{j′}⁻ denotes the j′ negative feedback interaction vector, Xᵤ_{ᵢ}⁻ denotes the i-th user uᵢ corresponding negative feedback interaction vector sequence, σ( ) denotes the sigmoid function, ŷᵤ_{ᵢ}ⱼ denotes the recommendation score calculated from the comprehensive user preference representation and the positive feedback interaction vector in the training set, ŷᵤ_{ᵢ}_{j′} denotes the recommendation score computed from the comprehensive user preference representation and the negative feedback interaction vector in the training set, θ denotes the model parameters, ∥θ∥² denotes the regularization of the model parameters L2 regularization, and λ_{θ} denotes the weights.

7. The method for recommending user preferences based on neural set operations according to claim 6, characterized in that said regularization constraint loss L_{SetReg} is expressed as:
$${L}_{SetReg} = {\sum }_{f ( z ) ∈ R} ( \frac{1}{\vert z \vert} {Σ}_{z ∈ Z} f ( z ) ) \qquad ( 8 )$$
wherein z is a set of vectors including a sequence of positive feedback interaction vectors corresponding to a single input sample, a sequence of negative feedback interaction vectors, and a vector of global user preferences, the positive feedback preference representation and the negative feedback preference representation obtained by the set operation, and the comprehensive user preference representation computed by the multi-layer perceptron mapping, Z denotes the set of z corresponding to multiple input samples, ƒ(z) denotes the single regularization constraint function corresponding to the ensemble operation, and R is the set of regularization constraint functions including the ƒ(z) as:
ƒ(z)=1−DEC(UNION(z,EMPTY),EMPTY)
ƒ(z)=1−DEC(UNION(z,z),z)
ƒ(z)=1−DEC(INTERSECTION(z,EMPTY),EMPTY)
ƒ(z)=1−DEC(INTERSECTION(z,z),z)
ƒ(z)=1−DEC(DIFFERENCE(z,EMPTY),z)
ƒ(z)=1−DEC(DIFFERENCE(EMPTY,z),EMPTY)
wherein EMPTY is a randomly initialized vector, UNION( ) denotes the union operation, DEC( ) denotes the similarity function, DIFFERENCE( ) denotes the difference operation, and DIFFERENCE( ) denotes the intersection operation.

8. A user preference recommendation device based on neural set operations, comprising a memory, a processor, and a computer program stored in said memory and executable on said processor, characterized in that said memory stores the neural set operations model constructed by the user preference recommendation method based on neural set operations of claim 1, said processor executing the computer program implements as following steps:
extracting all positive feedback interaction items and negative feedback interaction items from user interaction history information, and construct positive feedback interaction sequences and negative feedback interaction sequences respectively by arranging all positive feedback interaction items and negative feedback interaction items in the order of interaction time; obtaining user global preference information;
encoding positive and negative feedback interaction sequences into a sequence of positive and negative feedback interaction vectors, respectively, and encoding user global preference information into a user global preference vector;
learning comprehensive preference representation with the neural set operations model including set operation and multi-layer perceptron comprising: performing a union operation on a time-nearest plurality of positive feedback interaction vectors drawn from a sequence of positive feedback interaction vectors followed by a difference operation with a time-nearest plurality of negative feedback interaction vectors drawn from a sequence of negative feedback interaction vectors to obtain a positive feedback preference representation; performing a union operation on a time-nearest plurality of negative feedback interaction vectors extracted from the negative feedback interaction vector sequence, performing the difference set operation on a time-nearest plurality of positive feedback interaction vectors from the positive feedback interaction vector sequence to obtain negative feedback preference representation; the positive feedback preference representation, the negative feedback preference representation and the global user preference embeddings are mapped using a multi-layer perceptron to obtain the comprehensive user preference representation;
the similarity between the comprehensive user preference representation and the corresponding vector of multiple candidate interaction items is calculated, and the similarity is used as the recommendation score to rank the candidate interaction items, and the user preference is recommended based on the ranking result.
